(19) United States
(12) Patent Application Publication
(10) Pub. No.: US 2011/0254654 A1
(43) Pub. Date: Oct. 20, 2011

(54) Battery Car Anti-Theft Device

(76) Inventors: Chung-Ho LO, Taipei City (TW); Lin-Mei Chao, Sijhih City (TW); Ling-Chu Chao, Banciao City (TW); Ya-Chi Huang, Sansia Townhsip (TW); Hsin-Chin Huang, Sansia Township (TW)

(21) Appl. No.: 12/256,843

(22) Filed: Oct. 23, 2008

(51) Int. Cl. G05B 23/02

(52) U.S. Cl. 340/3.1

(57) ABSTRACT

A battery car anti-theft device, which is mainly characterized in utilizing an electronic control circuit to control the external power supply state of a battery, and when set in the anti-theft state, if it is detected that the supply current is greater than a preset value, then the entire external power supply of the battery is immediately cut off, thus, there is no power supply to start the engine to enable the car thief to drive the vehicle away, thereby achieving the objective of preventing the vehicle from being stolen.

### BACKGROUND OF THE INVENTION

(a) Field of the Invention

The present invention relates to a battery car anti-theft device, and more particularly to an anti-theft protection device which effects switching off the battery supply to prevent starting of an automobile.

(b) Description of the Prior Art

Previous car batteries were lead-acid batteries, which comprised a container holding lead plates and acid, thus, it was impossible to install some controllers within the container to control current output. Hence, car thieves only needed to cut the car lock electric wires and short-circuit contacts to easily start the engine and drive the vehicle away. Consequently, previous car batteries were completely unusable as an anti-theft tool.

If a device was designed that was able to switch off the power source of a battery, thereby preventing a car thief from being able to start the engine, thus, apart from towing the vehicle away or replacing the battery, otherwise the car thief would be unable to steal the vehicle, and the vehicle owner would be provided with an additional layer of safeguard.

After repeated reflection on the aforementioned problem, the inventor of the present invention believes using an acid-free lithium battery having the characteristic of needing no maintenance, and designing a sealed container with a control board installed therein to enable controlling the battery output terminals from the interior, and when needed, immediately cutting off output of external power, would prevent the car thief from being able to start the engine and drive the vehicle away.

Accordingly, the inventor of the present invention has designed a completely new battery current control device, which, when needed, cuts off the external power supply of the battery, thereby achieving providing safer anti-theft protection for the vehicle owner.

### SUMMARY OF THE INVENTION

A primary objective of the present invention is to use a control circuit to control the external power supply state of a car battery, whereby, after the vehicle owner activates an anti-theft function, if a thief breaks into the vehicle and attempts to start the engine, then the car battery immediately switches off the external power supply, thereby preventing the engine from being started, and the thief is unable to drive the vehicle away.

In order to achieve the aforementioned objective, the present invention implements the following method:

A circuit board is designed with a current detection circuit, and after the anti-theft function is activated, then as soon as the current detection circuit detects that the output current of the battery is greater than a preset value, then a signal is immediately transmitted to a master control circuit, whereupon a MCU (Master Control Unit) transmits an instruction to cut off the power supply, thereby causing a switch, originally in a conducting state, to immediately trip and cut off the power to supply circuit, at which time the external power output of the car battery assumes a no-power state, thus preventing the car engine from being started and preventing the thief from driving the vehicle away.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 is a schematic circuit structure of a battery car anti-theft device of the present invention.

### DETAILED DESCRIPTION OF THE PREFERRED EMBODIMENTS

Because the electric current used when starting an automobile greatly exceeds that used when the automobile is normally stopped, thus, a current decision value is set so that as soon as the electric current exceeds the set decision value, then it represents that the automobile is being started, at which time, if the automobile is provided with an anti-theft function, then the external power output of a car battery (10) is immediately shut off.

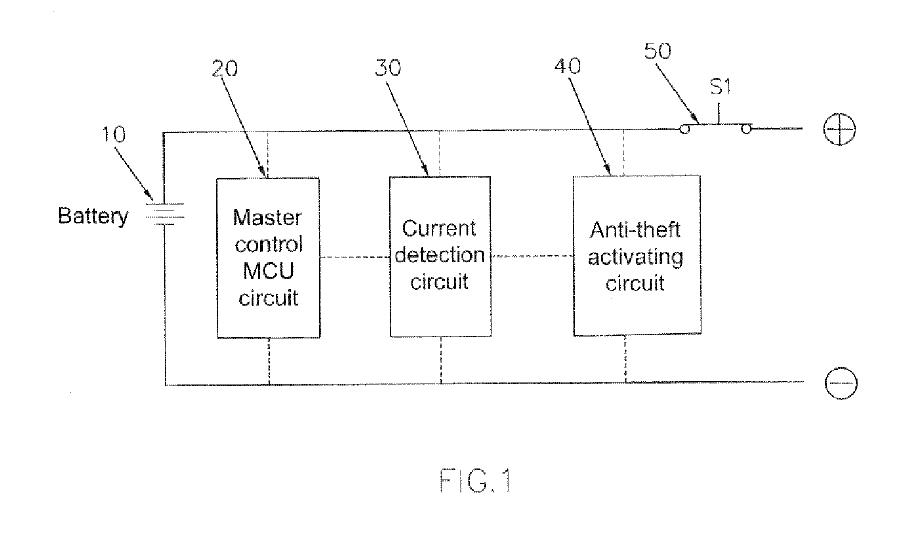

Referring to FIG. 1, which shows that the present invention primarily comprises the car battery (10); a circuit board is located within the car battery (10), and a master control MCU (Master Control Unit) (microprocessor) circuit (20), a current detection circuit (30) and an anti-theft activating circuit (40) are disposed on the circuit board. The master control MCU circuit (20), the current detection circuit (30), the anti-theft activating circuit (40) and the car battery (10) are connected in parallel, A switch (50) is installed to any line of a positive or negative pole of the output terminals of the car battery (10) and is concealed within the car battery (10), thereby enabling cutting off the power supply circuit of the car battery (10). Furthermore, the master control MCU circuit (20) is preset with a program and a current decision value.

After the anti-theft activating circuit (40) has been activated, then the current detection circuit (30) begins detecting output current of the car battery (10), and detected data is transmitted to the master control MCU circuit (20). When the output current exceeds the preset current decision value, then the master control MCU circuit (20) immediately transmits an instruction to direct the switch (50) to trip and break the circuit, thereby causing the external current output of the car battery (10) to be in a no-current state, and preventing the car engine from starting. Accordingly, the thief is unable to drive the vehicle away.

After the anti-theft activating circuit (40) has been activated, then the car battery (10) will still supply power to each electric component of the automobile within the preset current value, and will not affect other normal operations; only the engine is disabled from being started.

After the anti-theft activating circuit (40) has been switched off, then the master control MCU circuit (20) disables the switch (50) from effecting a tripping circuit instruction operation.

The anti-theft activating circuit (40) can be connected to a controller (not shown in the drawings), and the controller can be used to activate the anti-theft activating circuit (40) by wired means.

The anti-theft activating circuit (40) can be connected to a remote control (not shown in the drawings) (such as: a car remote control), and the remote control can be used to activate the anti-theft activating circuit (40) by wireless means.

The switch (50) can be a relay provided with the ability to control contact switching, electric current circulation or has a disconnection function or can be a MOS (metal oxide semiconductor).

The present invention is a distinctive, novel and inventive conceptual design, having little structure, and if other small circuitry is simply attached to the present invention, while the overall characteristics utilize the characteristics of the present invention, then such simple attachments are embraced within the scope of the present invention.

The present invention is provided with the aforementioned advantages, including ease of operation and simple manufacturing process; moreover, the present invention saves on cost, and is thus clearly provided with industrial utility value. Moreover, structural applications similar to that of the present invention have not been seen in publications or in public use, thus complying with the essential elements as required for a new patent application. Accordingly, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A battery car anti-theft device, comprising a car battery, a circuit board is located within the car battery, a master control MCU (Master Control Unit) (microprocessor) circuit, a current detection circuit and an anti-theft activating circuit are disposed on the circuit board, and the master control MCU circuit, the current detection circuit and the anti-theft activating circuit are connected to the car battery; a switch is installed to line of a pole of one of the output terminals of the car battery and is concealed within the car battery;
the master control MCU circuit is preset with a program and a current decision value;
after the anti-theft activating circuit is activated, then the current detection circuit begins detecting output current of the car battery, and detected data is transmitted to the master control MCU circuit; when the output current exceeds the preset current decision value, then the master control MCU circuit immediately transmits an instruction to direct the switch to trip and break the circuit, thereby causing the external current output of the car battery to be in a no-current state, and preventing the car engine from starting.

2. The battery car anti-theft device according to claim 1, wherein the anti-theft activating circuit is connected to a controller, and the controller is used to activate the anti-theft activating circuit by wired means.

3. The battery car anti-theft device according to claim 1, wherein the anti-theft activating circuit is connected to a controller, and the controller is used to activate the anti-theft activating circuit by wireless means.

4. The battery car anti-theft device according to claim 3, wherein the remote control is a car remote control.

5. The battery car anti-theft device according to claim 1, wherein the switch is a relay provided with the ability to control contact switching, electric current circulation or has a disconnection function or a MOS (metal oxide semiconductor).
